(19) United States
(12) Patent Application Publication
(10) Pub. No.: US 2014/0262741 A1
(43) Pub. Date: Sep. 18, 2014

(54) HEAT TRANSFER IN DISTILLATION COLUMNS

(71) Applicant: ELWHA LLC, Bellevue, WA (US)

(72) Inventors: Jeffrey A. Bowers, Issaquah, WA (US); Roderick A. Hyde, Redmond, WA (US); Muriel Y. Ishikawa, Livermore, CA (US); Nathan P. Myhrvold, Medina, WA (US); Thomas Allan Weaver, San Mateo, CA (US); Lowell L. Wood, JR., Bellevue, WA (US); Richard N. Zare, Stanford, CA (US)

(21) Appl. No.: 13/829,468

(22) Filed: Mar. 14, 2013

(51) Int. Cl. B01D 3/32

(52) U.S. Cl. CPC B01D 3/32
USPC 203/87; 261/146; 261/148

(57) ABSTRACT

A heat pipe is configured relative to a distillation column to adjust one or more conditions in the distillation column.

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application is related to and/or claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)). In addition, the present application is related to the “Related Applications,” if any, listed below.

### PRIORITY APPLICATIONS

None.

### RELATED APPLICATIONS

None.

The United States Patent Office (USPTO) has published a notice to the effect that the USPTO's computer programs require that patent applicants reference both a serial number and indicate whether an application is a continuation, continuation-in-part, or divisional of a parent application. Stephen G. Kunin, Benefit of Prior-Filed Application, USPTO Official Gazette Mar. 18, 2003. The USPTO further has provided forms for the Application Data Sheet which allow automatic loading of bibliographic data but which require identification of each application as a continuation, continuation-in-part, or divisional of a parent application. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant has provided designation(s) of a relationship between the present application and its parent application(s) as set forth above and in any ADS filed in this application, but expressly points out that such designation(s) are not to be construed in any way as any type of commentary and/or admission as to whether or not the present application contains any new matter in addition to the matter of its parent application(s).

If the listings of applications provided above are inconsistent with the listings provided via an ADS, it is the intent of the Applicant to claim priority to each application that appears in the Priority Applications section of the ADS and to each application that appears in the Priority Applications section of this application.

All subject matter of the Priority Applications and the Related Applications and of any and all parent, grandparent, great-grandparent, etc. applications of the Priority Applications and the Related Applications, including any priority claims, is incorporated herein by reference to the extent such subject matter is not inconsistent herewith.

### SUMMARY

In one embodiment, an apparatus comprises a distillation column including at least three trays, a pressure mechanism operably connected to the distillation column to control respective pressures of the at least three trays, and at least one heat pipe operably connected to each of the at least three trays to thermally connect each of the at least three trays.

In another embodiment, an apparatus comprises a distillation column including at least one tray and a heat pipe having a first section and a second section, wherein the first section of the heat pipe is located in a first region proximate to the at least one tray and the second section of the heat pipe is located in a second region proximate to the at least one tray, the first region being different from the second region, and wherein the heat pipe is configured to transfer heat between the first and second sections responsive to a temperature differential between the first and second regions.

In another embodiment, a method comprises changing respective pressures of at least three trays in a distillation column and thermally connecting the at least three trays, wherein the thermal connection is selected to substantially isothermalize the at least three trays.

In another embodiment, a method comprises thermally connecting a first region proximate to a tray in a distillation column to a second region proximate to the tray with a heat pipe and transferring heat between the first region and the second region with the heat pipe.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 is a schematic of a distillation column.

FIG. 2 is a schematic of a distillation column.

FIG. 3 is a schematic of a distillation column.

FIG. 4 is a schematic of a distillation column.

FIG. 5 is a schematic of two distillation columns.

FIG. 6 is a schematic of a distillation column and circuitry.

FIGS. 7-10 are flow charts depicting a method.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

In one embodiment, shown in FIG. 1, an apparatus comprises a distillation column 100 including at least three trays 102, a pressure mechanism 104 operably connected to the distillation column 100 to control respective pressures of the at least three trays 102, and at least one heat pipe 106 operably connected to each of the at least three trays 102 to thermally connect each of the at least three trays 102. In some embodiments, the pressure mechanism 104 is a pump. FIG. 1 shows the pressure mechanism 104 being operably connected to the distillation column 100 to control respective pressures P₁, P₂, and P₃ of three trays 102 (where, in FIG. 1, the regions 108, 110, and 112 each include one of the at least three trays 102 and are configured to support different pressures), however in other embodiments the pressure mechanism 104 is operably connected to more than three trays 102. Further, although the pressure mechanism 104 is shown in FIG. 1 as being one unit, in other embodiments the pressure mechanism 104 may comprise more than one unit. For example, in some embodiments each tray 102 is operably connected to a separate device configured to maintain and/or alter the pressure of the tray 102.

Further, although the at least one heat pipe 106 is shown as being a single heat pipe, other embodiments may include more than one heat pipe 106 depending on the particular embodiment. Although the heat pipe 106 is shown as branched, other embodiments may include an unbranched configuration in which the heat pipe thermally couples to each of the three or more trays. There are many ways of configuring heat pipes and one of skill in the art may adapt the configuration according to a particular embodiment. For example, although the heat pipe 106 is shown as being a branch structure made substantially of tubular-shaped pipes, in other embodiments the spatial extent of the heat pipe may have a different configuration. For example, the heat pipe may be configured in a different way than shown in FIG. 1, such as an embodiment where one or more portions of the heat pipe is/are configured to extend spatially along two dimensions defined by one or more of the trays 102. In such an embodiment, portions of the heat pipes that are operably connected to individual trays 102 may be connected together by a substantially one-dimensional structure (such as the pipes shown in FIG. 1), a two dimensional structure such as a plane, or a different structure. The heat pipes 106 as shown herein show exemplary embodiments of the configuration of a heat pipe 106 that is selected for clarity in the drawings, however the actual configuration of the heat pipe depends on the particular embodiment. The term “heat pipe” as used herein includes a device for heat transfer whose spatial distribution is determined by the particular application and may be substantially two or three dimensional, and need not actually resemble a “pipe” in appearance.

Although the heat pipe 106 and pressure mechanism 104 are shown in FIG. 1 as being operably connected to three trays, in other embodiments one or both elements 104, 106 may be operably connected to more than three trays.

In some embodiments the pressure mechanism 104 is operably connected to the distillation column 100 to maintain substantially different pressures for each of the at least three trays 102. In such an embodiment, the pressures may be maintained differently in order to adjust the vaporization temperatures of the at least three trays. For example, in some embodiments it may be beneficial for the at least three trays 102 to have substantially equal operating temperatures (i.e., the at least three trays 102 are substantially isothermalized), which may be achieved by providing different pressures for the at least three trays 102 and/or using one or more heat pipes 106 to thermally connect the at least three trays 102.

In some embodiments the at least three trays 102 are arranged sequentially, and wherein the pressure mechanism 104 is operably connected to the distillation column 100 to maintain a substantially monotonic variation in pressure of the sequential arrangement. For example, the lowest tray 102 may have the lowest pressure, the tray above it may have a slightly higher pressure, and the tray above it may have an even slightly higher pressure, producing a substantially monotonic variation in pressure of the trays 102. Or, the pressure variation may be opposite that described previously, with pressure decreasing with increasing height in the column. Further, in some embodiments the trays 102 are not arranged vertically but horizontally, i.e., side by side, or they may have a different spatial arrangement. In such an embodiment the sequence of the trays 102 is determined by the flow of fluid/vapor in the distillation column 100.

In some embodiments the apparatus further comprises a flow assembly operably connected to at least two of the at least three trays 102 to transfer material from a first of the at least three trays 102 to a second of the at least three trays 102. For example, in order to achieve substantially isolated pressures for each of the trays 102, the trays may be sealed off such that the fluid in the distillation column is pumped between trays 102 instead of flowing by gravity. In one embodiment the flow assembly is selected to transfer material responsive to a pressure differential. In different embodiments the flow assembly includes at least one of a pump, a valve, and a nozzle.

In some embodiments the trays 102 in the distillation column 100 may be arranged horizontally instead of vertically, as shown in FIG. 2. An embodiment such as FIG. 2 may include the elements as shown in FIG. 1, including, but not limited to, the pressure mechanism 104 and/or the heat pipes 106. In an embodiment where the trays 102 are arranged horizontally as shown in FIG. 2, fluid flow between adjacent trays 102 can be controlled by adjusting the pressure at each tray. The heat pipe 106 may be branched (as illustrated in FIG. 2) or may be unbranched, and/or may have a different configuration entirely as described with respect to FIG. 1.

In one embodiment, shown in FIG. 3, an apparatus comprises a distillation column 100 including at least one tray 102 and a heat pipe 106 having a first section 302 and a second section 304, wherein the first section 302 of the heat pipe 106 is located in a first region 306 proximate to the at least one tray 102 and the second section 304 of the heat pipe 106 is located in a second region 308 proximate to the at least one tray 102, the first region 306 being different from the second region 308, and wherein the heat pipe 106 is configured to transfer heat between the first and second sections 302, 304 responsive to a temperature differential between the first and second regions 306, 308. Such an embodiment may be employed to maintain a substantially even temperature within the tray 102, i.e. to substantially isothermalize the first and second regions 306, 308 and/or the entire tray 102. In some embodiments this isothermalization may increase the homogeneity of distillation products within the tray 102.

The first and second regions 306, 308 are examples of regions that are substantially isothermalized with the heat pipe 106, however these regions are exemplary and the regions affected by the heat pipe 106 may be larger or smaller than those shown in FIG. 3. Further, due to the nature of heat flow the regions affected by the heat pipe 106 are not necessarily clearly defined having a hard boundary as indicated by the regions 306, 308, and the regions 306, 308 are merely shown as an example of what may be considered a region affected by the heat pipe 106. Although FIG. 3 is shown having a single heat pipe 106, other embodiments include more than one heat pipe 106. Although the first and second regions 306, 308 are shown as being partially overlapping in FIG. 3, in some embodiments the regions are not overlapping. Although the heat pipe 106 is shown in FIG. 3 as being branched into first and second sections 302, 304, other layouts may be used. In one embodiment, heat pipe 106 in unbranched, with first section 302 and second section 304 occupying different portions along the length of the heat pipe. In one embodiment, the heat pipe 106 is located along a length of tray 102, thermally transferring heat to/from regions of tray 102 along the length. In some embodiments, the heat pipes can have plate-like configurations and may be configured to match the shape or dimensions of the tray. In some embodiments, the heat pipe may be built-in to the tray (e.g., integrally forming the base of the tray). Further, as described with respect to FIG. 1, the spatial distribution of the heat pipe 106 may have many different configurations according to a particular embodiment.

In some embodiments the heat pipe 106 has a third section 310 different from the first and second sections 302, 304, and wherein the third section 310 of the heat pipe 106 is located in a source region 312 different from the first and second regions 306, 308, the source region 312 including a temperature source, and wherein the heat pipe 106 is configured to transfer heat between the third section 310 and the first and second sections 302, 304 responsive to a temperature differential between the source region 312 and at least one of the first and second regions 306, 308. For example, as shown in FIG. 3, the source region 312 may be located outside of the distillation column and may be, for example, a liquid having a temperature that is controllable by one or more heating and/or refrigeration elements, where the temperatures of the first and second regions 306, 308 may be controlled by controlling the temperature of the source region 312. The heat source and/or coolant, thermometers, and other control and/or measurement devices are, in some embodiments, operably connected to circuitry (explained in more detail with respect to FIG. 6) configured to control the temperature of the source region 312 in response to one or more measurements of the source region 312, the first and second regions 306, 308, and/or a different region. In some embodiments the source region 312 is located outside the distillation column 100 as shown in FIG. 3, however this is not required.

In one embodiment, shown in FIG. 4, an apparatus comprises a distillation column 100, a heat pipe 106 having a first section 302 and a second section 304, the first section 302 being located in a first region 306 proximate to a first tray 402 of the distillation column 100, and a temperature source 404, wherein the second section 304 of the heat pipe 106 is located in a source region 312 that includes the temperature source 404, and wherein the heat pipe 106 is configured to transfer heat between the first and second sections 302, 304 responsive to a temperature differential between the first region 306 and the source region 312. Here, the temperature source 404 is explained in greater detail with respect to FIG. 3, where the source region 312 includes a temperature source. In some embodiments, as described previously with respect to FIG. 3, the heat pipe 106 is configured to substantially isothermalize the first region 306 with the source region 312.

In some embodiments the apparatus further comprises circuitry 406 operably connected to the temperature source 404 to control the temperature of the source region 312. In this embodiment the apparatus may further comprise a thermometer 408 configured to determine the temperature of the first region 306 and/or the source region 312 and operably connected to the circuitry 406 to control the temperature of the source region 312. Although a thermometer 408 is shown as a way of determining the temperature of regions 306 and 312, other embodiments include other mechanism for indirectly determining temperature, such as a device for measuring pressure.

In some embodiments the heat pipe 106 may comprise a variable conductance heat pipe. In some embodiments the heat pipe 106 has adjustable thermal conditions, for example, an adjustable internal pressure and/or an adjustable fluid composition. Some embodiments further comprise circuitry 406 operably connected to the heat pipe 106 to control the adjustable thermal conditions. In some embodiments the circuitry 406 is further receptive to a signal indicative of a condition of the temperature source 404 to control the adjustable thermal conditions of the heat pipe 106.

In one embodiment, shown in FIG. 5, an apparatus comprises first and second distillation columns 502, 504 having substantially equivalent parts and a heat pipe 106 operably connected to a first tray 506 of the first distillation column 502 and a second tray 508 of the second distillation column 504, wherein the first and second trays 506, 508 are substantially equivalent parts.

In the embodiment shown in FIG. 5, the first and second distillation columns 502, 504 having substantially equivalent parts are substantially identical having the same number of trays. However, in other embodiments the first and second distillation columns 502, 504 having substantially equivalent parts may include one or more portions of the distillation columns 502, 504 that are substantially equivalent. For example, in one embodiment the distillation columns 502, 504 have substantially equivalent parts up to a certain height of the distillation columns 502, 504, and parts above that height are not substantially equivalent. Further, although FIG. 5 shows an embodiment having two distillation columns 502, 504 with substantially equivalent parts, other embodiments may include three or more distillation columns having substantially equivalent parts.

In some embodiments the first and second distillation columns 502, 504 having substantially equivalent parts are each configured to produce one or more products 510, 512, the products 510, 512 being substantially the same for both the first and second distillation columns 502, 504.

In one embodiment, shown in FIG. 6, an apparatus comprises circuitry 602 configured to receive a first signal 604 corresponding to a condition of a first region 306 of a first distillation column 100, circuitry 602 configured to process the first signal 604 and to determine a second signal 606 corresponding to an altered condition of the first region 306 of the first distillation column 100, and circuitry 602 configured to produce the second signal 606, the second signal 606 being indicative of a change in a condition of a thermal connection between the first region 306 and a source region 608 outside the distillation column 100.

In some embodiments the condition of the first region 306 includes a temperature of the first region 306, and in some embodiments the second signal 606 is indicative of a change in temperature of the source region 608. In some embodiments the condition of the first region 306 includes an amount of a product 610 produced in the first region 306 and/or a pressure of the first region 306.

In some embodiments the second signal 606 is indicative of a change in temperature of the source region 608. In some embodiments the second signal 606 is indicative of a change in a thermal condition of a heat pipe 612 connecting the first and source regions 306, 608, where the thermal condition includes a pressure and/or a fluid composition in different embodiments.

The distillation columns 100 shown in FIGS. 1-6 are shown with 6 trays 102 each for clarity. However, the number of trays 102 of a distillation column depends on the particular embodiment, and a distillation column 100 may have more or fewer than 6 trays depending on the particular embodiment.

The heat pipes 106 are generally shown in FIGS. 1-6 as elongated tubes. In some embodiments, the heat pipes can be tubular with a circular cross-section, a rectilinear cross-section, a cross-section having a different spatial distribution, and/or some combination of cross-sections depending on the particular embodiment. For example, in some embodiments the heat pipe cross section may vary along the length of the heat pipe, for example, the cross-section may have substantially circular geometry in one section and have substantially rectilinear geometry in another. In some embodiments, one or more sections of the heat pipes may include one or more portions having a cross-section that is large compared to the length of the heat pipe (i.e., that portion of the heat pipe may be substantially two- or three-dimensional in its spatial extent), and may be configured to match the shape or dimensions of the tray and/or temperature source. In some embodiments the evaporation and the condensation sections of the heat pipe are physically separate from each other. In other embodiments there may be no physical distinction between the heat pipe's evaporation and its condensation sections, but only ephemeral distinctions based on the current direction of heat flow between the heat pipe and its surroundings. In some embodiments, the heat pipe may be built-in to the tray (e.g., integrally forming the base of the tray).

The heat pipes 106 may comprise substantially tubular heat pipes, vapor chambers, variable conductance heat pipes, loop heat pipes, or similar sealed heat transfer devices utilizing reversible liquid-vapor phase changes of a contained working fluid. The selection, working fluids, and operational principles of heat pipes are discussed in reference books such as, “Heat Pipes, Fifth Edition: Theory, Design, and Applications”, by David Reay, Ryan McGlen, and Peter Kew, Butterworth-Heinemann, 2006, as well as in technical papers such as, “Heat Pipe, Selection of Working Fluid” by Per Wallin, each of which is incorporated herein by reference. The working fluid may be chosen based on the temperature range over which the heat pipe will be used. A hydrocarbon distillation column may use heat pipes having different working fluids for different trays, i.e., based on the boiling point of the distillation product handled by a given tray. For example: heat pipes used for trays processing naptha might use methanol, acetone, or water; heat pipes used for trays processing gasoline or diesel might use water, thermex, or flutec; and heat pipes used for trays processing lubricating oils or fuel oils might use mercury, cesium, or sulfur/iodine mixtures. In other distillation applications having different thermal conditions, other heat pipe working fluids may be used, for instance: nitrogen or ammonia for cryogenic distillation; or potassium, sodium or lithium for high temperature distillation. These are exemplary embodiments and one of skill in the art might select the particular working fluid(s) and configuration of the heat pipe(s) 106 according to a particular embodiment.

In one embodiment, depicted in the flow chart of FIG. 7 (see also FIG. 1), a method comprises (702) changing respective pressures of at least three trays 102 in a distillation column 100 and (704) thermally connecting the at least three trays 102 (for example, with the heat pipe 106), wherein the thermal connection 106 is selected to substantially isothermalize the at least three trays 102.

In some embodiments changing respective pressures of at least three trays 102 in a distillation column includes maintaining substantially different pressures for each of the at least three trays 102.

In some embodiments the method further comprises transferring material from a first of the at least three trays 102 to a second of the at least three trays 102, where in some embodiments transferring material includes pumping material, and in some embodiments transferring material includes establishing a pressure differential between at least two of the at least three trays 102.

In one embodiment, depicted in the flow chart of FIG. 8 (see also FIG. 3), a method comprises (802) thermally connecting a first region proximate to a tray in a distillation column (for example, the first region 306) to a second region 308 proximate to the tray (for example, the second region 308) with a heat pipe 106 and (804) transferring heat between the first region 306 and the second region 308 with the heat pipe 106.

In some embodiments transferring heat between the first region 306 and the second region 308 with the heat pipe 106 includes substantially isothermalizing the distillation column tray 102.

In some embodiments the method may further comprise thermally connecting the first and second regions 306, 308 to a source region 312 with the heat pipe 106, wherein the source region 312 includes a temperature source. In some embodiments the source region 312 is located outside the distillation column 100.

In some embodiments the first region 306 overlaps at least partially with the second region 308.

In one embodiment, depicted in the flow chart of FIG. 9 (see also FIG. 3), a method comprises thermally connecting a first region 306 proximate to a tray in a distillation column 100 to a source region 312 with a heat pipe 106, wherein the thermal connection substantially isothermalizes the first region 306 and the source region 312, and changing the temperature of the first region 306 with the thermal connection 106.

In different embodiments, changing the temperature of the first region 306 with the thermal connection 106 includes heating the source region 312, cooling the source region 312, and/or receiving a first signal indicative of a temperature and changing the temperature of the source region 312 in response to the first signal.

In different embodiments the first signal is indicative of a temperature of the first region 306 and/or a temperature of the source region 312.

In some embodiments changing the temperature of the first region 306 with the thermal connection 106 includes changing a thermal condition of the thermal connection 106, which, in some embodiments, further includes changing a pressure of the thermal connection 106, changing a fluid composition of the thermal connection 106, and/or receiving a signal and changing the thermal condition of the thermal connection 106 responsive to the signal, where in some embodiments the signal includes information related to a condition of the temperature source.

In one embodiment, depicted in the flow chart of FIG. 10 (see also FIG. 5), a method comprises thermally connecting a first region 514 of a first distillation column 502 to a second region 516 of a second distillation column 504, wherein the first region 514 and the second region 516 are substantially equivalent regions, and substantially isothermalizing the first and second regions 514, 516 with the thermal connection.

In some embodiments the first region 514 corresponds to a first tray 506 in the first distillation column 502 and the second region 516 corresponds to a second tray 508 in the second distillation column 504, and wherein the first and second trays 506, 508 are substantially equivalent.

In some embodiments each of the first and second distillation columns 502, 504 includes an array of trays, wherein the array of trays in the first distillation column 502 is substantially equivalent to the array of trays in the second distillation column 504, and the method further comprises thermally connecting each of the trays in the first distillation column 502 with an equivalent tray in the second distillation column 504 and substantially isothermalizing each of the trays in the first distillation column 502 with the equivalent tray in the second distillation column 504.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include software or other control structures. Electronic circuitry, for example, may have one or more paths of electrical current constructed and arranged to implement various functions as described herein. In some implementations, one or more media may be configured to bear a device-detectable implementation when such media hold or transmit a device detectable instructions operable to perform as described herein. In some variants, for example, implementations may include an update or modification of existing software or firmware, or of gate arrays or programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or invoking circuitry for enabling, triggering, coordinating, requesting, or otherwise causing one or more occurrences of virtually any functional operations described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled//implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

In a general sense, those skilled in the art will recognize that the various embodiments described herein can be implemented, individually and/or collectively, by various types of electro-mechanical systems having a wide range of electrical components such as hardware, software, firmware, and/or virtually any combination thereof and a wide range of components that may impart mechanical force or motion such as rigid bodies, spring or torsional bodies, hydraulics, electro-magnetically actuated devices, and/or virtually any combination thereof. Consequently, as used herein “electro-mechanical system” includes, but is not limited to, electrical circuitry operably coupled with a transducer (e.g., an actuator, a motor, a piezoelectric crystal, a Micro Electro Mechanical System (MEMS), etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), electrical circuitry forming a communications device (e.g., a modem, communications switch, optical-electrical equipment, etc.), and/or any non-electrical analog thereto, such as optical or other analogs. Those skilled in the art will also appreciate that examples of electro-mechanical systems include but are not limited to a variety of consumer electronics systems, medical devices, as well as other systems such as motorized transport systems, factory automation systems, security systems, and/or communication/computing systems. Those skilled in the art will recognize that electro-mechanical as used herein is not necessarily limited to a system that has both electrical and mechanical actuation except as context may dictate otherwise.

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

Those skilled in the art will recognize that at least a portion of the devices and/or processes described herein can be integrated into an image processing system. Those having skill in the art will recognize that a typical image processing system generally includes one or more of a system unit housing, a video display device, memory such as volatile or non-volatile memory, processors such as microprocessors or digital signal processors, computational entities such as operating systems, drivers, applications programs, one or more interaction devices (e.g., a touch pad, a touch screen, an antenna, etc.), control systems including feedback loops and control motors (e.g., feedback for sensing lens position and/or velocity; control motors for moving/distorting lenses to give desired focuses). An image processing system may be implemented utilizing suitable commercially available components, such as those typically found in digital still systems and/or digital motion systems.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

Those skilled in the art will recognize that it is common within the art to implement devices and/or processes and/or systems, and thereafter use engineering and/or other practices to integrate such implemented devices and/or processes and/or systems into more comprehensive devices and/or processes and/or systems. That is, at least a portion of the devices and/or processes and/or systems described herein can be integrated into other devices and/or processes and/or systems via a reasonable amount of experimentation. Those having skill in the art will recognize that examples of such other devices and/or processes and/or systems might include—as appropriate to context and application—all or part of devices and/or processes and/or systems of (a) an air conveyance (e.g., an airplane, rocket, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Qwest, Southwestern Bell, etc.), or (g) a wired/wireless services entity (e.g., Sprint, Cingular, Nextel, etc.), etc.

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory).

A sale of a system or method may likewise occur in a territory even if components of the system or method are located and/or used outside the territory.

Further, implementation of at least part of a system for performing a method in one territory does not preclude use of the system in another territory.

All of the above U.S. patents, U.S. patent application publications, U.S. patent applications, foreign patents, foreign patent applications and non-patent publications referred to in this specification and/or listed in any Application Data Sheet are incorporated herein by reference, to the extent not inconsistent herewith.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

Although user is shown/described herein as a single illustrated figure, those skilled in the art will appreciate that user may be representative of a human user, a robotic user (e.g., computational entity), and/or substantially any combination thereof (e.g., a user may be assisted by one or more robotic agents) unless context dictates otherwise. Those skilled in the art will appreciate that, in general, the same may be said of “sender” and/or other entity-oriented terms as such terms are used herein unless context dictates otherwise.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) can generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. An apparatus comprising:
a distillation column including at least three trays;
a pressure mechanism operably connected to the distillation column to control respective pressures of the at least three trays; and
at least one heat pipe operably connected to each of the at least three trays to thermally connect each of the at least three trays.

2. The apparatus of claim 1 wherein the pressure mechanism is operably connected to the distillation column to maintain substantially different pressures for each of the at least three trays.

3. The apparatus of claim 1 wherein the at least three trays are arranged sequentially, and wherein the pressure mechanism is operably connected to the distillation column to maintain a substantially monotonic variation in pressure of the sequential arrangement.

4. The apparatus of claim 1 further comprising:
a flow assembly operably connected to at least two of the at least three trays to transfer material from a first of the at least three trays to a second of the at least three trays.

5. The apparatus of claim 4 wherein the flow assembly is selected to transfer material responsive to a pressure differential.

6. The apparatus of claim 4 wherein the flow assembly includes at least one of a pump, a valve, and a nozzle.

7. The apparatus of claim 1 wherein the at least one heat pipe is further operably connected to each of the at least three trays to substantially isothermalize each of the at least three trays.

8. An apparatus comprising:
a distillation column including at least one tray; and
a heat pipe having a first section and a second section, wherein the first section of the heat pipe is located in a first region proximate to the at least one tray and the second section of the heat pipe is located in a second region proximate to the at least one tray, the first region being different from the second region, and wherein the heat pipe is configured to transfer heat between the first and second sections responsive to a temperature differential between the first and second regions.

9. The apparatus of claim 8 wherein the heat pipe is arranged to substantially isothermalize the first region and the second region.

10. The apparatus of claim 8 wherein the heat pipe is arranged to substantially isothermalize the at least one tray.

11. The apparatus of claim 8 wherein the heat pipe has a third section different from the first and second sections, and wherein the third section of the heat pipe is located in a source region different from the first and second regions, the source region including a temperature source, and wherein the heat pipe is configured to transfer heat between the third section and the first and second sections responsive to a temperature differential between the source region and at least one of the first and second regions.

12. The apparatus of claim 11 wherein the source region is located outside the distillation column.

13. The apparatus of claim 8 wherein the first region overlaps at least partially with the second region.

14. The apparatus of claim 8 wherein the first section of the heat pipe is thermally coupled to the first region.

15. The apparatus of claim 8 wherein the second section of the heat pipe is thermally coupled to the second region.

16. The apparatus of claim 8 wherein the heat pipe is physically integrated with the tray.

17. The apparatus of claim 8 wherein the heat pipe forms at least a portion of the tray.

18. A method comprising:
establishing respective pressures of at least three trays in a distillation column; and
thermally connecting the at least three trays, wherein the thermal connection is selected to substantially isothermalize the at least three trays.

19. The method of claim 18 wherein establishing respective pressures of at least three trays in a distillation column includes maintaining substantially different pressures for each of the at least three trays.

20. The method of claim 18 further comprising:
transferring material from a first of the at least three trays to a second of the at least three trays.

21. The method of claim 20 wherein transferring material includes pumping material.

22. The method of claim 20 wherein transferring material includes establishing a pressure differential between at least two of the at least three trays.

23. The method of claim 22 wherein transferring material further includes transferring material through at least one of a nozzle and a valve.

24. The method of claim 18 wherein thermally connecting the at least three trays comprises thermally connecting the three trays with one or more heat pipes.

25. A method comprising:
thermally connecting a first region proximate to a tray in a distillation column to a second region proximate to the tray with a heat pipe; and
transferring heat between the first region and the second region with the heat pipe.

26. The method of claim 25 wherein transferring heat between the first region and the second region includes:
substantially isothermalizing the first and second regions.

27. The method of claim 26 wherein substantially isothermalizing the first and second regions includes:
isothermalizing the distillation column tray.

28. The method of claim 25 further comprising:
thermally connecting the first and second regions to a source region with the heat pipe, wherein the source region includes a temperature source.

29. The method of claim 28 wherein the source region is located outside the distillation column.

30. The method of claim 25 wherein the first region overlaps at least partially with the second region.
